(19) United States
(12) Patent Application Publication
(10) Pub. No.: US 2019/0066711 A1
(43) Pub. Date: Feb. 28, 2019

(54) VOICE FILTERING SYSTEM AND METHOD

(71) Applicants: HONGFUJIN PRECISION ELECTRONICS (ZHENGZHOU) CO., LTD., Zhengzhou (CN); HON HAI PRECISION INDUSTRY CO., LTD., New Taipei (TW)

(72) Inventors: TSUNG-JEN CHUANG, Tu-Cheng (TW); JUN-WEI ZHANG, Zhengzhou (CN); DAN WANG, Zhengzhou (CN)

(21) Appl. No.: 15/802,415

(22) Filed: Nov. 2, 2017

(30) Foreign Application Priority Data
Aug. 30, 2017 (CN) 201710766457.7

(51) Int. Cl. G10L 21/0208; G10L 21/0216; H04N 5/232

(52) U.S. Cl. CPC G10L 21/0208; G10L 21/0216; G10L 2021/02163; G10L 2021/02087; H04N 5/23216

(57) ABSTRACT

A voice filtering system for controlling an electronic device includes a first storage unit, a voice acquiring unit, a voice analyzing unit, a voice determining unit, and a voice filtering unit. The first storage unit stores at least one first voice and the voice acquiring unit acquires a second voice. The voice analyzing unit analyzes sonic features of the first voice and the second voice and the determining unit detects and determines any differences in the sonic features between the first voice or voices and the second voice. The voice filtering unit filters out any such different features found. A voice filtering method is also presented.

### CROSS-REFERENCE TO RELATED APPLICATIONS

This application claims priority to Chinese Patent Application No. 201710766457.7, filed on Aug. 30, 2017, the contents of which are incorporated by reference herein.

### FIELD

The subject matter herein generally relates to voice control of electronic devices.

### BACKGROUND

Digital cameras or smartphones may capture people's voices or people's videos in noisy environments. Thus, obtained audio or video may include noise.

### BRIEF DESCRIPTION OF THE DRAWINGS

Implementations of the present technology will now be described, by way of example only, with reference to the attached figures.

FIG. 1 is a block diagram of a voice filtering system, according to a first exemplary embodiment.

FIG. 2 is a block diagram of a voice filtering system, according to a second exemplary embodiment.

FIG. 3 is a block diagram of a voice filtering system, according to a third exemplary embodiment.

FIG. 4 is a flowchart of a voice filtering method, according to a first exemplary embodiment.

FIG. 5 is a flowchart of a voice filtering method, according to a second exemplary embodiment.

FIG. 6 is a flowchart of a voice filtering method, according to a third exemplary embodiment.

FIG. 7 is a flowchart of block 406 in FIG. 6, according to an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

A definition that applies throughout this disclosure will now be presented.

The term “comprising” means “including, but not necessarily limited to”; it specifically indicates open-ended inclusion or membership in a so-described combination, group, series, and the like.

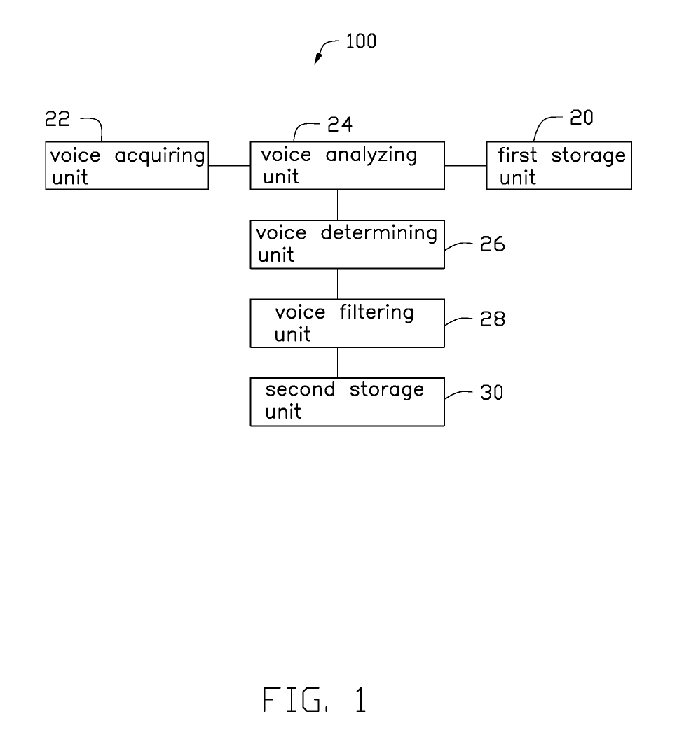

FIG. 1 illustrates a voice filtering system 100 employed in an electronic device. The voice filtering system 100 is configured to filter voice instructions to obtain desired commands. The voice filtering system 100 includes a first storage unit 20, a voice acquiring unit 22, a voice analyzing unit 24, a voice determining unit 26, and a voice filtering unit 28. The filtering system 100 further comprises at least one processor (not shown) for executing programs associated with at least one of the first storage unit 20, the voice acquiring unit 22, the voice analyzing unit 24, the determining unit 26 and the voice filtering unit 28.

The first storage unit 20 is configured to store at least one first voice. The voice acquiring unit 22 is configured to acquire a second voice. The voice analyzing unit 24 is configured to analyze features of the first voice and the second voice. Such features include timbre, tone and loudness. The determining unit 26 is configured to determine whether there are sounds different from the features of the first voice in the second voice. The voice filtering unit 28 is configured to filter the differences from the features of the first voice in the second voice. In the embodiment, the voice filtering system 100 further includes a second storage unit 30. The second storage unit 30 is configured to store the filtered second voice.

In an exemplary embodiment, the first storage unit 20 prestores a number of first voices. The voice analyzing unit 24 is configured to analyze features of each first voice and the second voice. The voice filtering unit 28 is configured to filter the differences in the second voice from the features of the number of the first voices.

In an exemplary embodiment, the voice acquiring unit 22 includes a microphone and the microphone captures the second voice. In another exemplary embodiment, the second voice is transmitted from another electronic device communicating with the electronic device.

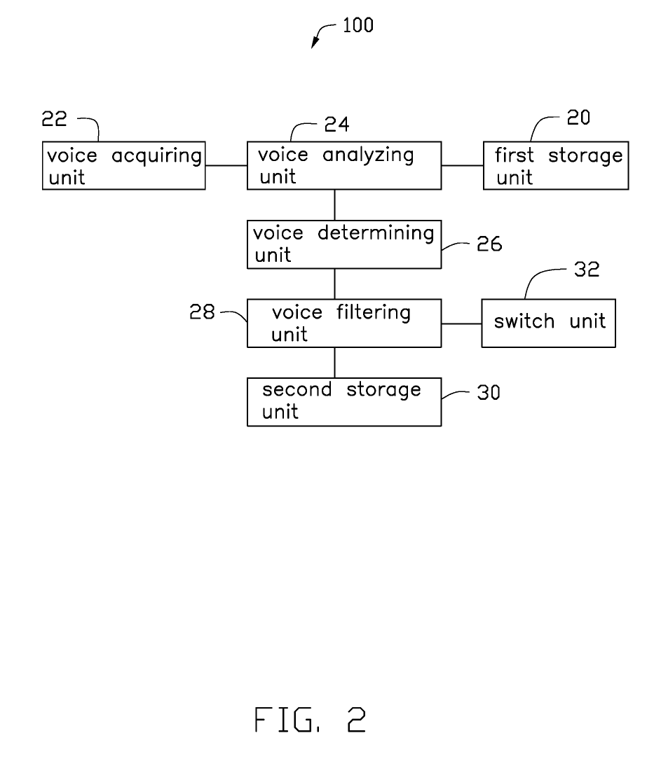

FIG. 2 illustrates that the voice filtering system 100 further includes a switch unit 32. The switch unit 32 is configured to control the voice filtering unit 28 to turn on or off. When the switch unit 32 controls the voice filtering unit 28 to turn on, the voice filtering unit 28 can filter the second voice. Otherwise, the voice filtering unit 28 does not filter the second voice.

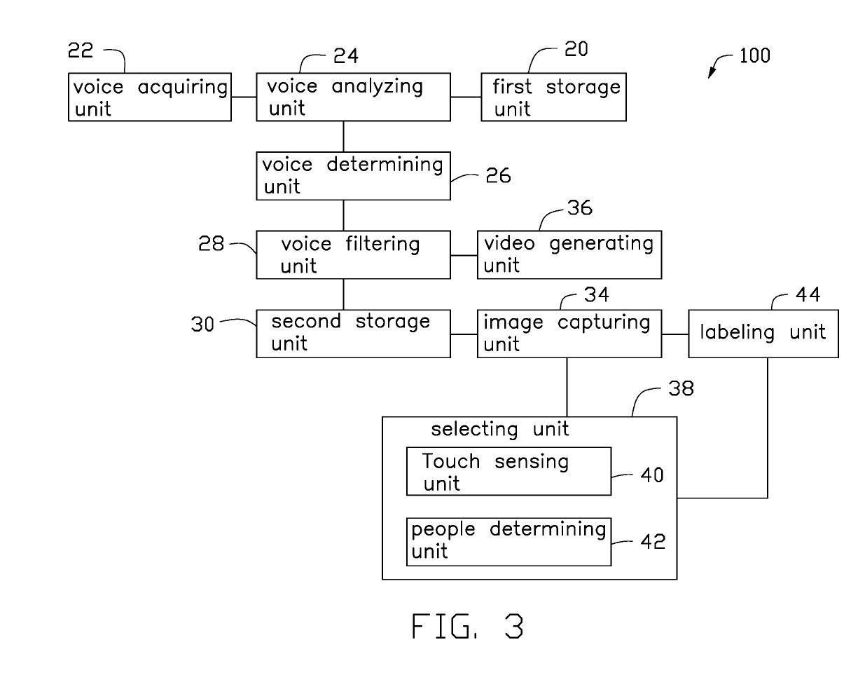

FIG. 3 illustrates the voice filtering system 100 further including an image capturing unit 34 and a video generating unit 36. The image capturing unit 34 is configured to capture images. The video generating unit 36 is configured to generate a video by the image and the second voice.

The voice filtering system 100 further includes a selecting unit 38. The selecting unit 38 is configured to select at least one target person in the image. The first voice is the voice of the target person.

The selecting unit 38 includes a touch sensing unit 40 and a people determining unit 42. The touch sensing unit 40 is configured to sense a touch position on the image. When there is no second touch in a preset time after sensing a first touch, the people determining unit 42 determines a part of image corresponding to the touch position as containing the target person. The preset time is two seconds.

The voice filtering system 100 further includes a labeling unit 44. The selecting unit 38 selects one target person. When the second voice is a voice of the target person, the labeling unit 44 labels the target person in the image with a first mark. The first mark is a flashing box.

When the touch sensing unit 40 senses the second touch, the labeling unit 44 further labels the part of the image with a second mark. The second mark can be a circle or a box.

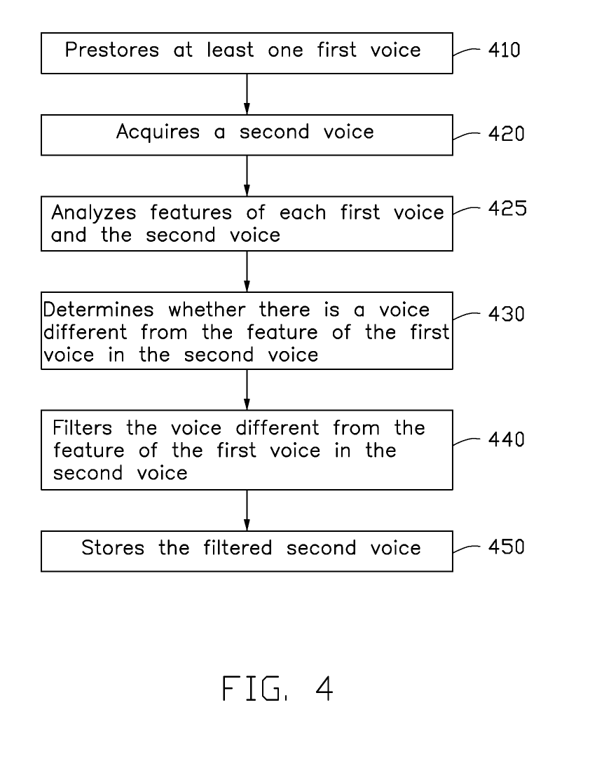

FIG. 4 illustrates a voice filtering method according to an embodiment. The order of blocks in FIG. 4 is illustrative only and the order of the blocks can change. Additional blocks can be added or fewer blocks may be utilized without departing from this disclosure. The exemplary method begins at block 410.

At block 410, the first storage unit 20 prestores at least one first voice.

At block 420, the voice acquiring unit 22 acquires a second voice.

At block 425, the voice analyzing unit 24 analyzes features of each first voice and the second voice.

At block 430, the determining unit 26 determines whether there is a difference in the features of the second voice from the first voice.

At block 440, the voice filtering unit 28 filters out such differences.

At block 450, the second storage unit 30 stores the filtered second voice.

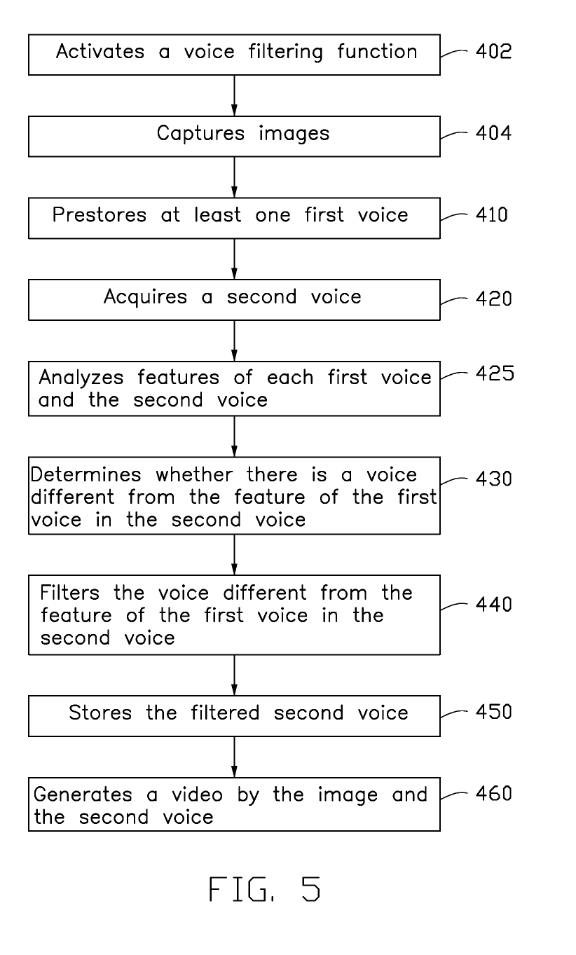

FIG. 5 illustrates a voice filtering method according to another embodiment. The voice filtering method further includes following blocks.

At block 402, the switch unit 32 activates a voice filtering function of the voice filtering unit 28. When the voice filtering function is activated, the different features in the second voice compared to the first voice can be filtered out.

At block 404, the image capturing unit 34 captures images.

At block 460, the video generating unit 36 generates a video of the image and the second voice.

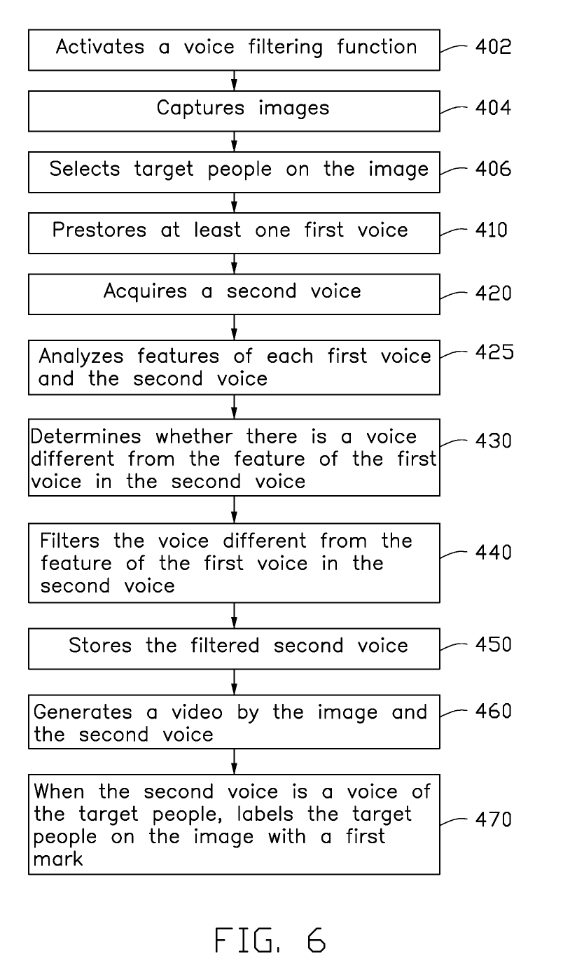

FIG. 6 illustrates a voice filtering method according to another embodiment.

At block 406, the selecting unit 38 selects target person on the image. The first voice is a voice of the target person.

At block 470, when the second voice is a voice of the target person, the labeling unit 44 labels the target person on the image with a first mark.

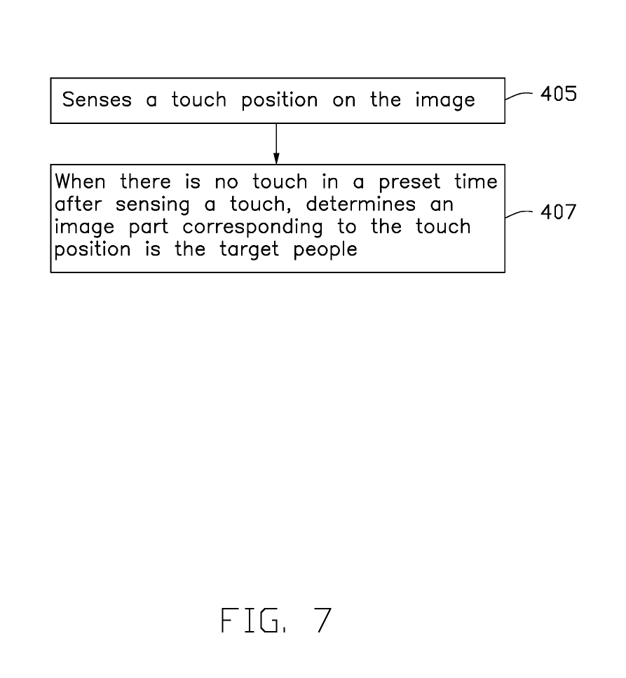

FIG. 7 illustrates that the block 406 includes following blocks.

At block 405, the touch sensing unit 40 senses a touch position on the image.

At block 407, when there is no second touch in a preset time after sensing a block 405 touch, the people determining unit 42 determines that a part of an image corresponding to the touch position is the target person.

The exemplary embodiments shown and described above are only examples. Even though numerous dataistics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A voice filtering system comprising:
a first storage unit configured to store at least one first voice;
a voice acquiring unit configured to acquire a second voice;
a voice analyzing unit configured to analyze features of the first voice and the second voice;
a determining unit configured to determine whether there is a voice different from the feature of the first voice in the second voice;
a voice filtering unit configured to filter the voice different from the feature of the first voice in the second voice; and
at least one processor for executing programs associated with at least one of the first storage unit, the voice acquiring unit, the voice analyzing unit, the determining unit and the voice filtering unit.

2. The voice filtering system as claimed in claim 1, wherein the feature comprises timbre, tone and loudness.

3. The voice filtering system as claimed in claim 1, wherein the voice acquiring unit comprises a microphone and the microphone captures the second voice.

4. The voice filtering system as claimed in claim 1, further comprising a second storage unit, wherein the second storage unit stores the filtered second voice.

5. The voice filtering system as claimed in claim 1, further comprising:
a switch unit, wherein the switch unit controls the voice filtering unit to turn on or off.

6. The voice filtering system as claimed in claim 1, further comprising:
an image capturing unit configured to capture images; and
a video generating unit configured to generate a video by the image and the second voice.

7. The voice filtering system as claimed in claim 1, further comprising:
a selecting unit configured to select at least one target person on the image, wherein the first voice is a voice of the target person.

8. The voice filtering system as claimed in claim 7, wherein the selecting unit comprises a touch sensing unit and a people determining unit, the touch sensing unit senses a touch position on the image, when there is no touch in a preset time after sensing a touch, the people determining unit determines an image part corresponding to the touch position is the target person.

9. The voice filtering system as claimed in claim 8, wherein the voice filtering system further comprises a labeling unit, the selecting unit selects one target person, when the second voice is a voice of the target person, the labeling unit labels the target person on the image with a first mark.

10. The voice filtering system as claimed in claim 9, wherein the first mark is a twinkling box.

11. A voice filtering method comprising:
storing at least one first voice;
acquiring a second voice;
analyzing features of the first voice and the second voice;
determining whether there is a voice different from the feature of the first voice in the second voice; and
filtering the voice different from the feature of the first voice in the second voice.

12. The voice filtering method as claimed in claim 11, wherein the feature comprises timbre, tone and loudness.

13. The voice filtering method as claimed in claim 11, further comprising acquiring the second voice by a microphone.

14. The voice filtering method as claimed in claim 11, further comprising:
storing the filtered second voice.

15. The voice filtering method as claimed in claim 11, further comprising:
activating a voice filtering function; and
wherein when the voice filtering function is activated, the voice different from the feature of the first voice in the second voice is able to be filtered.

16. The voice filtering method as claimed in claim 11, further comprising:
capturing images; and
generating a video by the image and the second voice.

17. The voice filtering method as claimed in claim 11, further comprising:
selecting at least one target person on the image, wherein the first voice is a voice of the target person.

18. The voice filtering method as claimed in claim 17, wherein selecting at least one target person on the image comprises:
sensing a touch position on the image; and
when there is no touch in a preset time after sensing a touch, determining an image part corresponding to the touch position is the target person.

19. The voice filtering method as claimed in claim 18, further comprising selecting one target person, and further comprising:
when the second voice is a voice of the target person, labeling the target person on the image with a first mark.

20. The voice filtering method as claimed in claim 11, wherein the first mark is a twinkling box.
